(19) United States
(12) Patent Application Publication
(10) Pub. No.: US 2025/0259832 A1
(43) Pub. Date: Aug. 14, 2025

(54) High-Throughput Analysis Using Ion Mobility and Mass Spectroscopy

(71) Applicant: DH Technologies Development Pte. Ltd., Singapore (SG)

(72) Inventors: Bradley B. SCHNEIDER, Bradford (CA); Chang LIU, Richmond HIll (CA); Stephen TATE, Barrie (CA)

(21) Appl. No.: 18/856,903

(22) PCT Filed: Apr. 14, 2023
(86) PCT No.: PCT/IB2023/053809

§ 371 Date: Oct. 15, 2024

Related U.S. Application Data
(60) Provisional application No. 63/363,021, filed on Apr. 14, 2022.
(60) Provisional application No. 63/444,086, filed on Feb. 8, 2023.
(60) Provisional application No. 63/447,400, filed on Feb. 22, 2023.
(60) Provisional application No. 63/447,408, filed on Feb. 22, 2023.

(51) Int. Cl. H01J 49/00; G01N 27/622; H01J 49/04

(52) U.S. Cl. CPC H01J 49/0027; G01N 27/622; H01J 49/0409; H01J 49/0431

(57) ABSTRACT

In one aspect, a method of operating a high-throughput mass analysis device is disclosed, which includes sampling an unseparated sample from at least one sample holding element during a sampling interval for introduction of the sample into an ion source for ionizing the sample to generate a plurality of ions associated with at least one target analyte (herein also referred to as a target compound), if any, in said sample for delivery to an ion mobility separation device, and activating at least one control parameter of said ion mobility separation device for detection of said ions based on timing of the sampling of the sample and at least one identifier associated with the sample.

### RELATED APPLICATIONS

This application claims priority to U.S. provisional application No. 63/363,021, filed on Apr. 14, 2022, entitled “High Throughput Analysis using Ion Mobility and Mass Spectrometry,” claims priority to U.S. provisional application No. 63/444,086, filed on Feb. 8, 2023, entitled High-Throughput Analysis Using Ion Mobility and Mass Spectroscopy, claims priority to U.S. provisional application No. 63/447,400, filed on Feb. 22, 2023, entitled “Systems and Methods for High Throughput Mass Spectrometry,” and claims priority to U.S. provisional application No. 63/447,408, filed on Feb. 22, 2023, entitled “Systems and Methods for Sync of Instrument Voltages with Orthogonal Ion Pulsing.” These applications are incorporated herein by reference in their entirety.

### TECHNICAL FIELD

The present disclosure relates to mass spectrometry and more particularly to methods and systems for performing high-throughput mass spectrometry.

### BACKGROUND

The present teachings are generally directed to systems and methods for performing high-throughput mass spectrometry.

Mass spectrometry (MS) is an analytical technique for determining the structure of test chemical substances with both qualitative and quantitative applications. MS can be useful for identifying unknown compounds, determining the composition of atomic elements in a molecule, determining the structure of a compound by observing its fragmentation, and quantifying the amount of a particular chemical compound in a mixed sample. Mass spectrometers detect chemical entities as ions such that a conversion of the analytes to charged ions must occur.

Due to its high specificity, wide dynamic range and high sensitivity, mass spectrometry has become one of the primary analytical platforms in high-throughput drug discovery to deliver high-fidelity and label-free analysis results. Various high-throughput mass spectrometer (MS) technologies have been developed in the past decades serving the needs of various drug discovery workflows, such as the million-compound-size high-throughput screening, High-throughput Adsorption, Distribution, Metabolism and Excretion/Elimination (ADME) screening, medicinal chemistry readout, compound Quality Control (QC), and bioanalysis.

To improve the analytical speed, various Liquid Chromatography (LC) free high-throughput MS technologies have been developed in the past decade, such as Matrix Assisted Laser Desorption Ionization (MALDI), Laser Diode Thermal Desorption (LDTD), Matrix-assisted laser desorption electrospray ionization (MALDESI), Acoustic Mist Ionization (AMI), Liquid atmospheric pressure matrix-assisted laser desorption/ionization (LAP-MALDI), Desorption electrospray ionization (DESI), Direct Analysis in Real Time (DART), as well as the Acoustic Ejection Mass Spectrometry (AEMS) technology we developed. The sample readout speed of 1-second-per-sample or even faster have been demonstrated.

However, there is still a need for improved methods and systems for performing mass spectrometry.

### SUMMARY

In one aspect, a method of operating a high-throughput mass analysis device is disclosed, which includes sampling an unseparated sample from at least one sample holding element during a sampling interval for introduction of the sample into an ion source for ionizing the sample to generate a plurality of ions associated with at least one target analyte (herein also referred to as a target compound), if any, in the sample for delivery to an ion mobility separation device, and activating at least one control parameter of the ion mobility separation device for detection of the ions based on timing of the sampling of the sample and at least one identifier associated with the sample. The step of activating the at least one control parameter can include utilizing a controller to set a value of said control parameter based on reference data indicative of said value of the control parameter suitable for identification of said target analyte.

In various embodiments, the activation of the at least one control parameter is delayed following the sampling of a sample by a time interval corresponding to the time between the sampling of the sample and the delivery of ions associated with the at least one target compound in the sample to the ion mobility separation device.

By way of example, the sample identifier can identify a sample holding element from which the sample is sampled and/or a target compound (herein also referred to as a target analyte) of interest associated with the sample. Further, in some embodiments, the identifier can identify a duration of the sampling interval, e.g., by identifying the start and the stop time associated with the sampling interval.

In some embodiments, the method further includes retrieving, e.g., from a datafile, data indicative of the at least one control parameter associated with the at least one target analyte, i.e., the value of the at least one control parameter that would be suitable for identification of the target analyte via the ion mobility separation device.

In some embodiments, a sample removed from a sample holding element can be interrogated for presence of a plurality of analytes (compounds). In such embodiments, the step of activating the at least one control parameter can include activating different values of the control parameter during the sampling interval, where each of those values of the control parameter is suitable for the detection of one of the plurality of analytes, when present in the sample.

In some embodiments, the at least one sample holding element can include a plurality of sample holding elements and the identifier can identify the sample holding element from which the sample is sampled as well as at least one target analyte associated with the sample, i.e., at least one target analyte to be detected, when present in the sample. In such embodiments, the at least one control parameter can be updated for each sample holding element, if needed, to configure the ion mobility separation device for identification of the target analyte in the sample associated with that sample holding element. In some embodiments, the identification of more than one target analyte in a sample associated with a sample holding element may be desired. In such cases, for each sample holding element, a plurality of sample portions can be removed from that sample holding element during a plurality of sampling events and the at least one control parameter can be adjusted for each sampling event to configure the ion mobility separation device to identify a different one of the target compounds of interest in that sampling event. In this manner, each sample that is sampled from each sample holding element can be interrogated for the presence of a plurality of target analytes.

In some embodiments, the sampling step can be performed via a plurality of discrete sampling events during a sampling interval. In other embodiments, the sampling step can be performed continuously during a sampling interval.

In some embodiments, the sampling interval can be equal to or less than about 10 seconds, for example, in a range of about 0.05 seconds to about 10 seconds, such as in the range of about 0.5 second to about 5 seconds.

In some embodiments, the sampling step includes utilizing an energy source for removing the sample from the sample holding element. By way of example, the energy source can be any of a laser, an acoustic source, an ultrasound source and a source for providing pneumatic pressure and/or heat, among others.

A variety of ion mobility separation devices can be utilized in the practice of the present teachings. By way of example, the ion mobility separation device can be any of an ion mobility spectrometer (IMS) and a differential mobility spectrometer (DMS). The IMS can include any known device including a drift tube, travelling wave IMS, TIMS, or Differential Mobility Analyzer (DMA). The DMS can include planar devices, cylindrical FAIMS, spherical FAIMS, or micromachined devices.

In embodiments in which the ion mobility separation device is an ion mobility spectrometer, the control parameter can be, for example, specific potentials applied to various lens elements, potential gradients, travelling wave potentials, ramp rates, travelling wave amplitude, travelling wave ramp rate, travelling wave velocity, gas composition, number of cycles in the case of a cyclic IMS device, drift tube length details, control voltages for directing ions along parallel IMS devices, gating times for shutters before and after an IMS device.

In embodiments in which the ion mobility separation device is a differential mobility spectrometer (DMS), the control parameter can include at least one of a separation voltage and a compensation voltage and a DMS offset voltage for application to the DMS. In some embodiments, the DMS can be a field asymmetric ion mobility spectrometer (FAIMS) and the at least one control parameter can be any of a dispersion voltage and a compensation voltage.

The sample holding element can take a variety of different forms. By way of example, and without limitation, the sample holding element can be a reservoir, e.g., a sample well, for containing a sample, such as a liquid sample. In other examples, the sample holding element can be a solid surface on which the sample in the form of isolated droplets is distributed. In yet another example, the sample holding element can include a solid surface on which dried sample spots are distributed, or any other surface or reservoir capable of holding a solid or a liquid sample.

In some embodiments, an acoustic ejection of the sample contained in the reservoir is employed for extracting the sample from the reservoir for delivery to the ion source.

In a related aspect, a method of operating a high-throughput mass analysis device is disclosed, which includes sampling an unseparated sample from at least one sample holding element during a sampling interval for introduction of the sample into an ion source for ionizing the sample to generate a plurality of ions associated with at least one analyte, if any, in said sample for delivery to an ion mobility separation device, accessing reference data to obtain a value of at least one control parameter of said ion mobility separation device for identification of said at least one analyte; and activating said at least one control parameter of said ion mobility separation device at said value for detection of said ions based on timing of the sampling of the sample.

The reference data can identify at least one target compound associated with said at least one sample holding element. Further, the reference data can provide the at least one control parameter for identification of the at least one target compound via the ion mobility separation device.

In a related aspect, a method of introducing a plurality of samples from a plurality of sample holding elements into an ion mobility separation device is disclosed, which includes sequentially sampling each of the sample holding elements for introducing a sample from the respective sample holding element into an ion source for generating ions associated with at least one target analyte, if any, in the sample. For each of the samples, the respective plurality of the ions is introduced into the ion mobility separation device and the following steps are performed for each of the samples introduced into the ion mobility separation device: generating a signal indicative of a sampling time of the sample and the target analyte associated with that sample and setting at least one control parameter of the ion mobility separation device so as to allow passage of ions associated with the target analyte through the ion mobility separation device. By way of example, and without limitation, the ion mobility separation device can be any of an ion mobility spectrometer, a differential mobility spectrometer, among others.

In another aspect, a high-throughput mass analysis device is disclosed, which includes at least one sample holding element for storing a sample, an ion source, an ion mobility separation device, and a sample introduction device for directing the sample from the at least one sample holding element to the ion source. The device can further include a controller that is in communication with the sample introduction device for controlling sampling of the sample from the at least one sample holding element for delivery to the ion source to cause ionization of at least one target analyte, if any, in the sample, thereby generating a plurality of ions associated with said target analyte, said controller further being in communication with the ion mobility separation device for controlling at least one control parameter thereof. The controller is configured to activate the at least one control parameter for detecting the target analyte in the sample based on timing of the sampling of the sample from the sample holding element and an identifier associated with the sample.

In some embodiments, the controller can be further configured to activate the at least one control parameter based on a combination of the timing of the sampling of the sample and the sample identifier and a time delay between the sampling of the sample and the delivery of the plurality of ions to the ion mobility separation device.

In some embodiments, the at least one sample holding element includes a plurality of sample holding elements and the sample identifier identifies the sample holding element from which the sample is extracted as well as at least one target analyte associated with that sample.

In some embodiments, the controller utilizes a predefined sampling schedule, e.g., a predefined sampling schedule retrieved from a datafile, to schedule the sampling of the plurality of sample holding elements. In some such embodiments, the datafile can further store the values of the at least one control parameter for identification of one or more target analytes in a sample associated with each of the plurality of the sample holding elements.

The ion mobility separation device can be, for example, an ion mobility spectrometer (IMS), a differential mobility spectrometer (DMS), e.g., a field asymmetric waveform ion mobility spectrometer (FAIMS). The control parameter can be one or more parameters that can be utilized to configure such ion mobility separation devices to identify a target compound of interest. By way of example, the control parameter can provide at least one of an ion separation voltage, a compensation voltage and an offset voltage for application to a DMS positioned downstream of the ion source for receiving the ions generated by the ion source. By way of further example, the controller parameter can be any of a dispersion voltage and a compensation voltage for application to the FAIMS.

In some embodiments, the identifier can identify the target analyte and the controller is configured to access the reference datafile to obtain a value of the at least one control parameter for identifying the target analyte in the ion mobility separation device.

In some embodiments, the reference datafile can further include data indicative of expected ion mobility separation between the target analyte and at least one potential interfering compound, such as an isobaric and/or isomeric compound, as a function of the at least one control parameter. Such data allows configuring the ion mobility separation device to distinguish between the target analyte and the potential interfering compound. For example, the data can indicate the separation voltage and the compensation voltage for application to a DMS so as to allow the passage of a target analyte, and not its isobaric compound or its isomer, through the DMS.

In some embodiments, the at least one sample holding element can include at least a sample reservoir for storing a liquid sample. In some such embodiments, an acoustic ejection device can be employed for ejecting the sample from the sample reservoir. In some embodiments, the ejected sample can be introduced into an open port interface (OPI) for delivery to a downstream ion source, which can cause ionization of a target analyte, if present in the sample, to generate a plurality of ions for delivery to a downstream ion mobility separation device, e.g., a DMS device.

In some embodiments, the sample holding element can be a solid substrate having sample holding portions distributed on a surface thereof. For example, the sample holding element can include a surface having an array of hydrophobic spots that can be used to confine droplets of a sample. In another example, the sample can be stored as dried sample spots on a solid surface of a sample holding element (e.g., a MALDI plate), or any other conductive or non-conductive surface suitable for holding a solid or liquid sample.

Further understanding of various aspects of the present teachings can be obtained via reference to the following detailed description in conjunction with the associated drawings, which are described briefly below.

### BRIEF DESCRIPTION OF THE DRAWINGS

FIG. 1A is a flow chart depicting various steps of an embodiment of a method according to the present teachings for performing high-throughput mass spectrometry,

FIG. 1B schematically depicts a system according to an embodiment for performing high-throughput mass spectrometry,

FIG. 2 shows an example of a datafile that can be utilized in various embodiments for configuring an ion mobility separation device for detection of a plurality of target analytes in a plurality of samples,

FIG. 3A shows an example of another datafile that can be utilized in various embodiments for configuring an ion mobility separation device for detection of a plurality of target analytes in a plurality of samples,

FIG. 3B shows examples of control parameters that can be employed for configuring an ion mobility separation device for the detection of the target analytes listed in the datafile depicted in FIG. 3A,

FIG. 4 presents exemplary hypothetical data depicting ion mobility of a target analyte relative to its isobaric and isomeric counterparts as a function of a separation voltage applied to a differential mass spectrometer,

FIG. 5 schematically depicts an acoustic ejection device for extracting samples from a sample reservoir and an open port interface (OPI) that receives the ejected samples, and

FIG. 6 schematically depicts an example of an implementation of a controller suitable for use in the practice of the present teachings.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein mean 10% greater or less than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

The term “unseparated sample,” as used herein, refers to a sample that has not been subjected to a chromatographic separation method that would result in separation of any of the analytes in the sample with a baseline resolution of the separated analytes. By way of example, an unseparated sample refers to a sample that has not been subjected to a chromatographic separation that would result in substantially complete separation of at least two of the analytes in the sample.

As noted above, a number of technologies for improving the speed of mass spectrometric analysis are known. Although some of these technologies can provide a high analysis speed at typically about 1-sec-per-sample or faster, these high-throughput MS technologies do not provide additional ion separation beyond the mass-to-charge ratio for species discrimination. Therefore, such technologies cannot be utilized to distinguish an analyte of interest from its isomeric/isobaric interferences existing in the sample solution or generated from the in-source fragmentation, thus limiting the potential specificity and/or sensitivity for some assays.

To address this limitation of lacking the chromatographic separation, an additional dimension of selectivity in addition to the m/z, such as ion mobility spectrometry (IMS), or differential mobility spectrometry (DMS) can be utilized to further expand the scope of mass analysis without adding much analysis time.

When acquiring multidimensional data, the sample throughput can be limited by the time required for each analysis dimension. For instance, DMS approaches require time to ramp the compensation voltage over a significant range and additional time is required to acquire MS data for each step of the compensation voltage ramp. Similarly, when combining IMS with MS, the throughput is limited by drift time in the first dimension and then mass analysis in the 2nd dimension. Alternatively, DMS devices may be operated at a fixed compensation voltage to enable high-throughput analysis.

Determination of the optimized system parameters can be critical for the DMS-MS or IMS-MS analysis in order to achieve sufficient separation resolution without sacrificing too much sensitivity or analysis speed, especially for high-throughput applications. Optimized DMS or IMS parameters depend typically, at least in part, on sample type and the analytes of interest to be separated by the separation device.

For example, for IMS, the resolving power (peak position/FWHM) is related to the sensitivity and drift time. For example, in order to obtain higher resolving power, the sensitivity would decrease, and a longer cycle time would be necessary. For DMS the resolution is related to sensitivity and analysis/residence time in the DMS.

In a conventional LC-MS, the MS system executes continuous acquisition for the duration of the elution time of a single sample introduced in a liquid chromatography (LC) column. The MS system may switch operational parameters during the elution time to match the expected analytes eluting at that point in the elution. As the elution time is typically over many minutes, and analytes are separated in time based on the solvent gradient being executed by the LC, MS parameter switching can be matched to a delay time from the start of the elution based on an expected order of elution from the LC column. In LC-MS, MS acquisition data for different samples are typically reordered separately. Due to the extended time scale for LC-MS analysis (minutes), saving the existing data to a file and starting a new data file, which is on the order of seconds or less, does not cause the challenge for LC-MS systems.

For high-throughput analysis with fast sampling-speed, each sampling event is on the order of seconds, with continuous 1 Hz sampling demonstrated for ADE-MS. Conventional techniques configure the MS system to execute continuous acquisition while sampling a plurality of different samples. In this case, the MS signal from the plurality of sampling events is continuously captured and recorded as a single data file. Alternatively, the MS signal can be captured to separate files. Alternatively, subsequent data processing steps may split the single data file into a corresponding plurality of data files.

There is a need for a high-throughput MS system that is capable of incorporating an ion separation device, such as a DMS (e.g., FAIMS) and/or IMS separation device, in order to provide additional separation in combination with the mass selection of an MS.

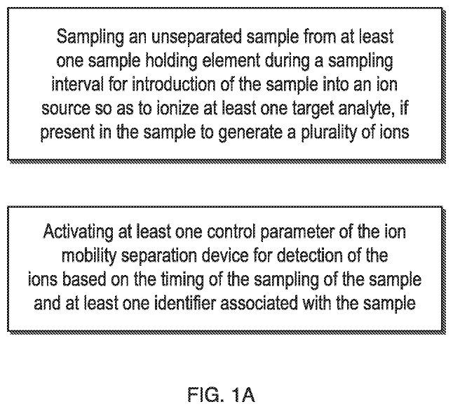

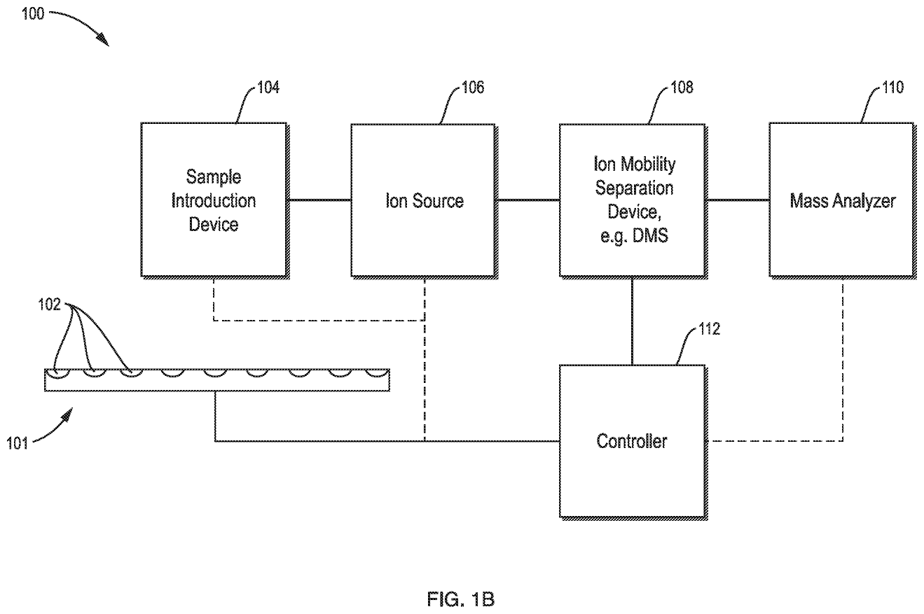

FIG. 1A shows a flow chart depicting various steps of a method according to an embodiment for operating a high-throughput mass analysis device, which comprises sampling an unseparated sample from at least one sample holding element during a sampling interval for introduction of the sample into an ion source for ionizing at least a target analyte, when present in the sample, to generate a plurality of ions associated with that target analyte for delivery to an ion mobility separation device, and activating at least one control parameter of the ion mobility separation device for detection of the ions based on timing of the sampling of the sample and at least one identifier associated with the sample. The step of activating the at least one control parameter can be further based on a delay time between the sampling of the sample and the delivery of the plurality of ions to the ion mobility separation device. In some cases, an unseparated sample may have undergone one or more separation processes prior to the above sampling step, but in such cases, the separation processes would not have resulted in separation of any of the analytes in the sample with a baseline resolution of the separated analytes.

FIG. 1B schematically depicts a system 100 according to an embodiment of the present teachings for performing high-throughput mass analysis, which includes a sample holding element 101, which in this embodiment is implemented as a plurality of reservoirs 102, e.g., in the form of a plurality of wells, in which a plurality of samples is stored.

A sample introduction device 104, e.g., an acoustic ejection system, is operably coupled to the sample reservoirs 102 for causing the extraction of samples from those reservoirs and their delivery to a downstream ion source 106, which, for each sample, ionizes at least a target analyte, if present in that sample, to generate a plurality of ions associated with that sample, where the ions are in turn received by an ion mobility separation device 108. In some embodiments, a sampling interface can be optionally positioned between the sample introduction device 104 and the ion source 106 to receive/dilute the samples sampled from the sample holding element. For example, an Open-Port Interface (OPI) can receive a sample ejected from a sample reservoir via acoustic ejection and can dilute and transfer the sample to a downstream ion source.

A mass analyzer 110 positioned downstream of the ion mobility separation device 108 can receive the ions passing through the ion mobility separation device and provide a mass analysis thereof. By way of example, the mass analyzer can be a quadrupole mass analyzer, a time-of-flight (ToF) mass analyzer, a combination thereof, among others. Without any loss of generality, and for the purposes of illustration, in this embodiment, the ion mobility separation device is a differential mobility spectrometer (DMS), though any other ion mobility separation device may also be employed.

The system 100 further includes a controller 112 that is configured to coordinate the extraction of the samples from the reservoirs and the activation of at least one control parameter of the DMS 108 for the detection of a target analyte within a particular sample, as discussed in more detail below. The controller 112 can also optionally control the operation of the sample introduction device 104, the ion source 106 as well as the mass analyzer 110.

More specifically, in one embodiment, the controller 112 can have access to a datafile, e.g., stored on a database external to the controller, or alternatively residing on the controller, that identifies, for each sample well, at least one target analyte of interest as well as one or more control parameters for identification of ions associated with that target analyte via the downstream ion mobility separation device 108.

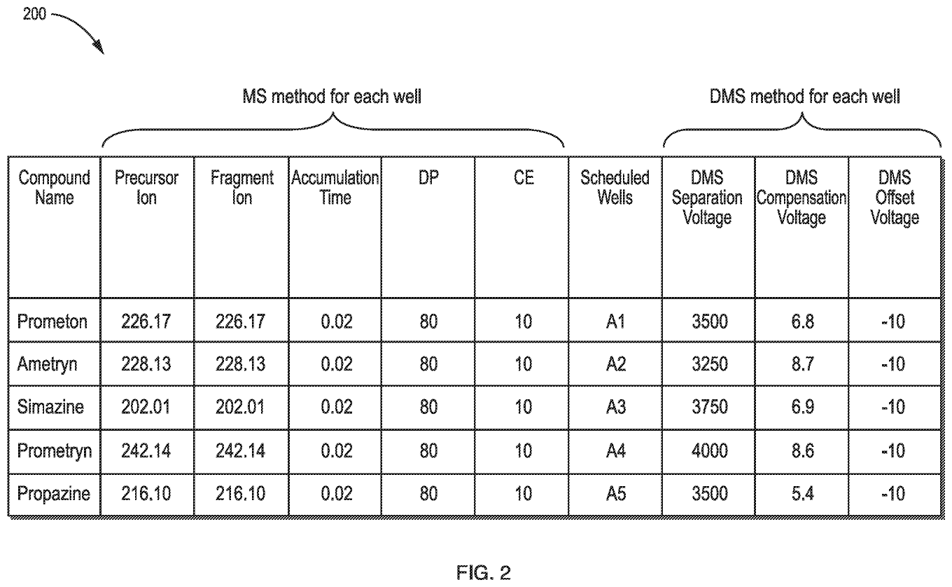

By way of illustration, FIG. 2 shows an example of such a datafile 200 that can be utilized by the controller 112 for setting the control parameter(s) of the ion mobility separation device 108. In this example, the datafile 200 is in the form of a table that identifies, for each well, the target analyte (herein also referred to as the target compound) of interest to be detected as well as the control parameters of a downstream differential mobility separation device, such as the DMS described above, which receives ions associated with that target analyte and, optionally, various operating parameters of a mass analyzer positioned downstream of the ion differential mobility separation device, such as the above mass analyzer 110.

More specifically, each row of the table corresponds to one sample well and the rows are ordered according to a predefined schedule for extracting samples from the wells. For example, for well A1, the table indicates that the target compound is Prometon and further identifies the m/z ratios associated with a precursor ion as well as a fragment ion corresponding to that compound. Moreover, for well A1, the control parameters of the DMS in the form of a separation voltage, a compensation voltage, and an offset voltage are indicated. In addition, the operating parameters of a mass analyzer positioned downstream of the DMS, i.e., accumulation time, DP (declustering potential) and CE (collision energy), are also provided. The table provides similar data for the other wells A2-A5. It is noted that any number of additional parameters may also be included in the table.

In use, the controller 112 can utilize this data to start sampling the wells in the order designated in the table, e.g., from A1-A5. For each well, the controller 112 can utilize the data in the table to generate control signals for transmission to the DMS. Optionally, the controller 112 can also provide control signals to a mass analyzer 110 positioned downstream of the DMS 108, which receives the ions passing through the DMS 108. In some embodiments, the mass analyzer 110 is configured for performing MS/MS analysis of the ions. In such embodiments, the mass analyzer may include a mass filter that is configured for selection of a precursor ion and a collision cell for causing the fragmentation of the selected precursor ion. As discussed above, the controller 112 can configure the DMS 108 based on the timing of the sampling of a particular well and an expected delay time associated with the transfer of the sample from the well to the DMS.

In this example, the data required for carrying out the analysis of the samples taken from all wells and the associated control parameters for operating the DMS are contained within a single datafile. This allows rapid sampling of the wells and processing of the samples via the DMS and the downstream mass spectrometer. In particular, the controller 112 can utilize the datafile to obtain information regarding a target compound to be detected subsequent to a current target compound, and hence can configure the DMS, via application of the appropriate control parameters thereto, so as to detect the next target compound with the process repeated until all of the wells and their associated target compounds are processed.

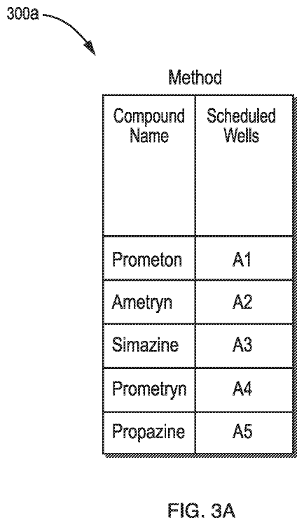

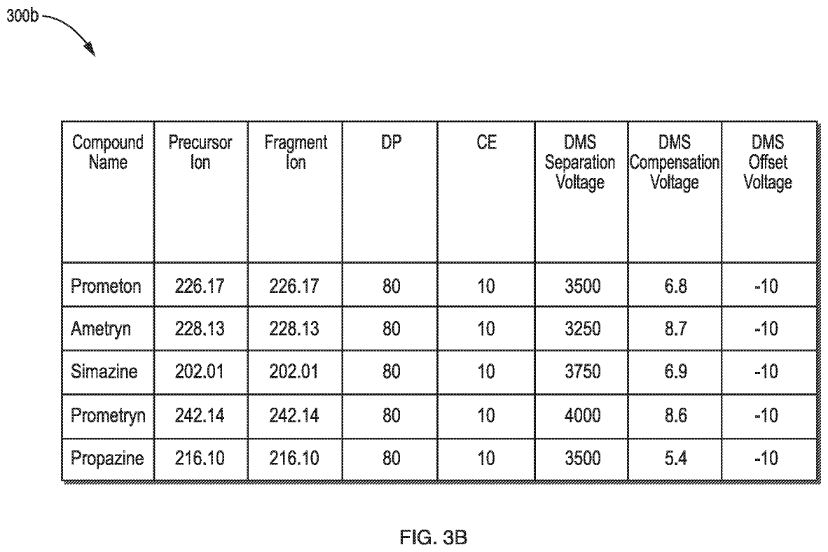

With reference to FIG. 3A, in some embodiments, a first reference data 300a utilized by the controller 112 can simply identify the target compound(s) of interest for each well scheduled to be sampled. In such a case, the controller 112 can access a second reference data (herein also referred to as an auxiliary reference data) that provides the requisite control parameters for operating the DMS for identification of each target compound identified in the first reference datafile. The first and the second reference data can be stored in a single datafile for use by the controller.

By way of example, FIG. 3B shows such an auxiliary reference datafile in which, for each of the target compounds identified in the table provided in FIG. 3A, the corresponding control parameters for operating the DMS as well as a mass analyzer positioned downstream of the DMS are provided. During mass analysis, the controller can access the auxiliary reference data to obtain the values of the DMS control parameters that are needed for the identification of each of the target compounds listed in the first datafile. In some such embodiments, at least one advantage of specifying only the name of a target compound for each sample holding element and relying on the controller to access the requisite parameters for that compound in an auxiliary reference datafile is providing a more convenient user setting, e.g., by eliminating the need for inputting all the required parameters for all compounds in a user interface of a mass spectrometer.

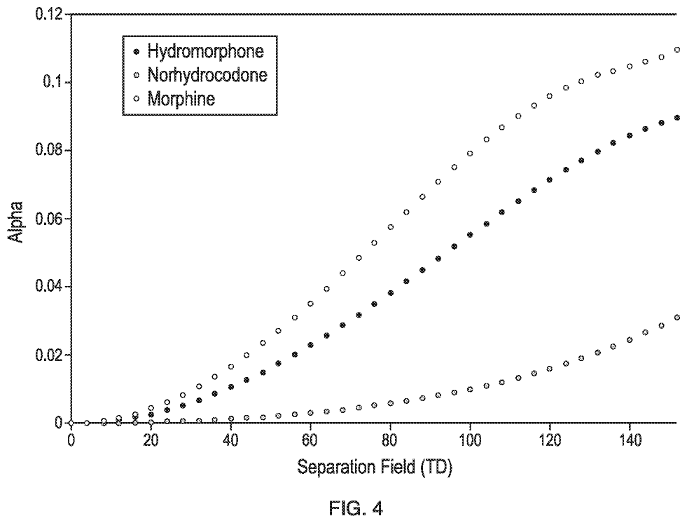

In some embodiments, reference data indicative of the ion mobility of a target compound relative to any of an isobaric compound and/or an isomer thereof can be utilized to configure the ion mobility separation device so as to distinguish the target compound from its isobaric and/or isomeric counterparts. By way of illustration, FIG. 4 schematically depicts hypothetical data corresponding to the mobility of a target compound (A) relative to an isobaric (B) and/or an isomeric counterpart as a function of amplitude of an RF waveform utilized to generate a separation voltage in a differential mobility spectrometer (DMS). The field strength E is normalized to the background gas density (N) and expressed in Townsends. This data can be utilized, e.g., by a controller of a system according to the present teachings, to set the separation voltage so as to ensure sufficient differential mobility between the target compound and its isobaric and isomeric counterparts to facilitate the detection of the selected target compound. By way of illustration, in this hypothetical example, an E/N value greater than about 100 may be utilized for the detection of the target compound (A).

For systems that incorporate an IMS, the control parameters may include different parameters, including but not limited to voltage amplitudes applied to specific lens elements, potential gradients, travelling wave potential amplitude and ramp rates, travelling wave speed, gas composition, number of cycles in the case of a cyclic IMS, drift tube length details, control voltages for directing ions along parallel IMS devices for instance with different lengths, gating times for shutters before, after, or within IMS devices to select a small subset of ions passing through, in addition to control info for a downstream mass analyzer to correlate one or more scan types or m/z measurement regions with IMS separation time and/or delay time resulting from transfer of ions through one or more regions, including an OPI, an IMS, and any other region.

Referring again to FIG. 1B, in use, the controller 112 can initiate the extraction of a sample portion from a particular sample well via sending a control signal (herein also referred to as a trigger signal) to the sample introduction device 104. The control signal can cause the extraction of the sample (or at least a portion thereof) from the sample well for delivery to the ion source 106. The ion source ionizes the target compound, if present in the extracted sample, and delivers the ions to the DMS 108.

By way of example, the controller sends control signals indicating the values of the separation voltage, the compensation voltage, and the offset voltage suitable for identification of the ions associated with the target compound to the DMS. In some embodiments, the controller sends the control signals to the DMS after a predefined delay, which is defined to account for the time interval between the application of the trigger to a sample well for extraction of a sample therefrom and the delivery of the ions associated with the target compound of interest, if present in the sample, to the DMS 108. The controller can repeat this process for the other sample wells until samples from all of the wells scheduled to be interrogated have been subjected to mass analysis.

In some embodiments, the controller sends a signal to a subsequent well to cause extraction of a sample therefrom while a current sample extracted from a previous well is being analyzed, e.g., as the current sample is being transmitted through the DMS. Given a time delay associated with the passage of the target compound through the DMS, the triggering of the sampling of the subsequent well can be configured to ensure that the ions associated with the subsequent sample well will arrive at the DMS immediately following the passage of the ions associated with a target compound from the previous well through the DMS. In general, in various embodiments, the time delay can depend, for example, on the technique utilized for sampling of the sample. For example, when acoustic ejection for ejecting a sample from a sample well and an open-port-interface for receiving the ejected sample are utilized, the time delay can be, for example, in a range of about 1 second to about 5 seconds, though other time delays may also be employed. Such an arrangement can further expedite the sampling and the processing of the samples contained in the wells.

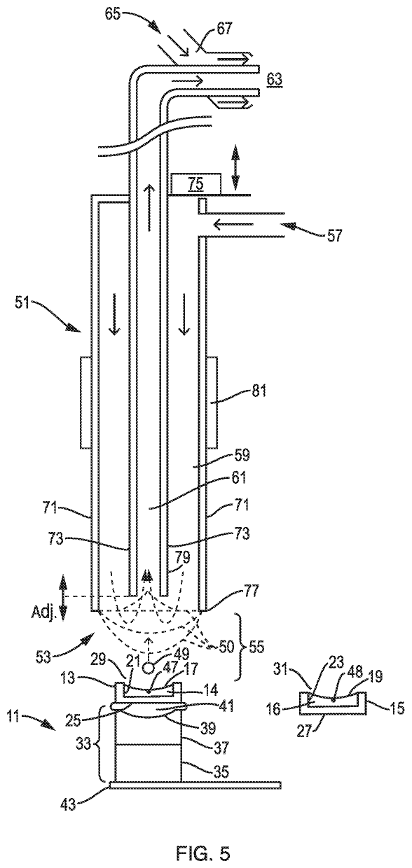

A variety of sample holding elements and sample introduction devices can be employed. With reference to FIG. 5, in some embodiments, the sample introduction device can include an Acoustic Droplet Ejector (ADE) device 11, which includes at least one reservoir. In this embodiment, the ADE device 11 includes a first reservoir shown at 13 and an optional second reservoir 31. In some embodiments, one or more additional reservoirs may be provided. Each reservoir is configured to house a fluid sample having a fluid surface, e.g., a first fluid sample 14 and a second fluid sample 16 having fluid surfaces respectively indicated at 17 and 19.

The fluid samples 14 and 16 may be the same or different. By way of example, the analyte may be a biomolecule or a macromolecule other than a biomolecule, or it may be a small organic molecule, an inorganic compound, an ionized atom, or any moiety of any size, shape, or molecular structure, as explained earlier in this section. In addition, the analyte may be dissolved, suspended or dispersed in the liquid component of the fluid sample.

In various embodiments, when more than one reservoir is used, as illustrated in FIG. 5, the reservoirs are preferably both substantially identical and substantially acoustically indistinguishable, although identical construction is not a requirement. In some embodiments, the reservoirs may be separate removable components in a tray, rack, or other such structure, but they may also be fixed within a plate, e.g., a well plate, or another substrate. Each reservoir is preferably substantially axially symmetric, as shown, having vertical walls 21 and 23 extending upward from circular reservoir bases 25 and 27, and terminating at openings 29 and 31, respectively, although other reservoir shapes and reservoir base shapes may be used. The material and thickness of each reservoir base should be such that acoustic radiation may be transmitted therethrough and into the fluid sample contained within each reservoir.

ADE device 11 includes an acoustic ejector 33, which includes acoustic energy generator 35 and focusing means 37 for focusing the acoustic radiation generated at a focal point 47 within the fluid sample, near the fluid surface. As shown in FIG. 5, the focusing means 37 may include a single solid piece having a concave surface 39 for focusing the acoustic energy, but the focusing means may be constructed in other ways, e.g., as discussed below.

The acoustic ejector 33 is thus adapted to generate and focus acoustic energy so as to eject a droplet of fluid from each of the fluid surfaces 17 and 19 when acoustically coupled to reservoirs 13 and 15, and thus to fluids 14 and 16, respectively. The acoustic radiation generator 35 and the focusing means 37 may function as a single unit controlled by a single controller, or they may be independently controlled, depending on the desired performance of the device.

Optimally, acoustic coupling is achieved between the ejector and each of the reservoirs through indirect contact, as illustrated in FIG. 5. In the figure, an acoustic coupling medium 41 is placed between the ejector 33 and the base 25 of reservoir 13, with the ejector and reservoir located at a predetermined distance from each other. The acoustic coupling medium may be an acoustic coupling fluid, preferably an acoustically homogeneous material in conformal contact with both the acoustic focusing means 37 and the underside of the reservoir. In addition, the fluid medium is substantially free of materials having different acoustic properties than the fluid medium itself. As shown, the first reservoir 13 is acoustically coupled to the acoustic focusing means 37 such that an acoustic wave generated by the acoustic radiation generator is directed by the focusing means 37 into the acoustic coupling medium 41, which then transmits the acoustic radiation into the reservoir 13. The system may contain a single acoustic ejector, as illustrated in FIG. 5, or it may contain multiple ejectors.

In operation, reservoir 13 and optional reservoir 15 of the device are filled with first and second fluid samples 14 and 16, respectively, as shown in FIG. 5. The acoustic ejector 33 is positioned just below reservoir 13, with acoustic coupling between the ejector and the reservoir provided by means of acoustic coupling medium 41. Initially, the acoustic ejector is positioned directly below sampling tip 53 of OPP 51 such that the sampling tip faces the surface 17 of the fluid sample 14 in the reservoir 13.

Once the ejector 33 and reservoir 13 are in proper alignment below sampling tip 53, the acoustic generator 35 is activated to produce acoustic energy that is directed by the focusing means 37 to a focal point 47 near the fluid surface 17 of the first reservoir. As a result, droplet 49 is ejected from the fluid surface 17 toward and into the liquid boundary 50 at the sampling tip 53 of the OPP 51, where it combines with solvent in the flow probe 53.

The profile of the liquid boundary 50 at the sampling tip 53 may vary from extending beyond the sampling tip 53 to projecting inward into the OPP 51. In a multiple-reservoir system, the reservoir unit (not shown), e.g., a multi-well plate or tube rack, can then be repositioned relative to the acoustic ejector such that another reservoir is brought into alignment with the ejector and a droplet of the next fluid sample can be ejected. The solvent in the flow probe cycles through the probe continuously, minimizing or even eliminating “carryover” between droplet ejection events.

Fluid samples 14 and 16 are samples of any fluid for which transfer to an analytical instrument is desired. Accordingly, the fluid sample may contain a solid that is minimally, partially or fully solvated, dispersed, or suspended in a liquid, which may be an aqueous liquid or a nonaqueous liquid. The structure of OPP 51 is also shown in FIG. 5. Any number of commercially available continuous flow OPPs can be used as is or in modified form, all of which, as is well known in the art, operate according to substantially the same principles. As can be seen in FIG. 5, the sampling tip 53 of OPP 51 is spaced apart from the fluid surface 17 in the reservoir 13, with a gap 55 therebetween. The gap 55 may be an air gap, or a gap of an inert gas, or it may include some other gaseous material; there is no liquid bridge connecting the sampling tip 53 to the fluid 14 in the reservoir 13.

The OPP 51 includes a solvent inlet 57 for receiving solvent from a solvent source and a solvent transport capillary 59 for transporting the solvent flow from the solvent inlet 57 to the sampling tip 53, where the ejected droplet 49 of analyte-containing fluid sample 14 combines with the solvent to form an analyte-solvent dilution. A solvent pump (not shown) is operably connected to and is in fluid communication with solvent inlet 57 in order to control the rate of solvent flow into the solvent transport capillary and thus the rate of solvent flow within the solvent transport capillary 59 as well.

Fluid flow within the probe 53 carries the analyte-solvent dilution through a sample transport capillary 61 provided by inner capillary tube 73 toward sample outlet 63 for subsequent transfer to an analytical instrument. A sampling pump (not shown) can be provided that is operably connected to and is in fluid communication with the sample transport capillary 61, to control the output rate from outlet 63.

Suitable solvent pumps and sampling pumps will be known to those of ordinary skill in the art, and include displacement pumps, velocity pumps, buoyancy pumps, syringe pumps, and the like; other examples are given in U.S. Pat. No. 9,395,278 to Van Berkel et al., the disclosure of which is incorporated by reference herein.

In various embodiments, a positive displacement pump can be used as the solvent pump, e.g., a peristaltic pump, and, instead of a sampling pump, an aspirating nebulization system can be used so that the analyte-solvent dilution is drawn out of the sample outlet 63 by the Venturi effect caused by the flow of the nebulizing gas introduced from a nebulizing gas source 65 via gas inlet 67 (shown in simplified form in FIG. 5, insofar as the features of aspirating nebulizers are well known in the art) as it flows over the outside of the sample outlet 63. The analyte-solvent dilution flow is then drawn upward through the sample transport capillary 61 by the pressure drop generated as the nebulizing gas passes over the sample outlet 63 and combines with the fluid exiting the sample transport capillary 61. A gas pressure regulator is used to control the rate of gas flow into the system via gas inlet 67.

In some cases, the nebulizing gas can flow over the outside of the sample transport capillary 61 at or near the sample outlet 63 in a sheath flow type manner which draws the analyte-solvent dilution through the sample transport capillary 61 as it flows across the sample outlet 63 that causes aspiration at the sample outlet upon mixing with the nebulizer gas.

The solvent transport capillary 59 and sample transport capillary 61 are provided by outer capillary tube 71 and inner capillary tube 73 substantially co-axially disposed therein, where the inner capillary tube 73 defines the sample transport capillary, and the annular space between the inner capillary tube 73 and outer capillary tube 71 defines the solvent transport capillary 59. The dimensions of the inner capillary tube 73 can be from 1 micron to 1 mm, e.g., 200 microns. Typical dimensions of the outer diameter of the inner capillary tube 73 can be from 100 microns to 3 or 4 centimeters, e.g., 360 microns. Typical dimensions of the inner diameter of the outer capillary tube 71 can be from 100 microns to 3 or 4 centimeters, e.g., 450 microns. Typical dimensions of an outer diameter of the outer capillary tube 71 can be from 150 microns to 3 or 4 centimeters, e.g., 950 microns. The cross-sectional areas of the inner capillary tube 73 and/or the outer capillary tube 71 can be circular, elliptical, superelliptical (i.e., shaped like a superellipse), or even polygonal. While the illustrated system in FIG. 5 indicates the direction of solvent flow as downward from the solvent inlet 57 toward sampling tip 53 in the solvent transport capillary 59 and the direction of the analyte-solvent dilution flow as upward from the sampling tip 53 upward through the sample transport capillary 61 toward outlet 63, the directions can be reversed, and the OPP 51 is not necessarily positioned to be exactly vertical. Various modifications to the structure shown in FIG. 5 will be apparent to those of ordinary skill in the art in view of the present teachings.

The system can also include an adjuster 75 coupled to the outer capillary tube 71 and the inner capillary tube 73. The adjuster 75 can be adapted for moving the outer capillary tube tip 77 and the inner capillary tube tip 79 longitudinally relative to one another. The adjuster 75 can be any device capable of moving the outer capillary tube 71 relative to the inner capillary tube 73. Exemplary adjusters 75 can be motors including, but not limited to, electric motors (e.g., AC motors, DC motors, electrostatic motors, servo motors, etc.), hydraulic motors, pneumatic motors, translational stages, and combinations thereof. As used herein, “longitudinally” refers to an axis that runs along the length of the OPP 51, and the inner and outer capillary tubes 73, 71 can be arranged coaxially around a longitudinal axis of the OPP 51.

Optionally, prior to use, the adjuster 75 is used to draw the inner capillary tube 73 longitudinally inward so that the outer capillary tube 71 protrudes beyond the end of the inner capillary tube 73 so as to facilitate optimal fluid communication between the solvent flow in the solvent transport capillary 59 and the sample transported as an analyte-solvent dilution flow in the sample transport capillary 61. Additionally, as illustrated in FIG. 5, the OPP 51 is generally affixed within an approximately cylindrical holder 81, for stability and ease of handling.

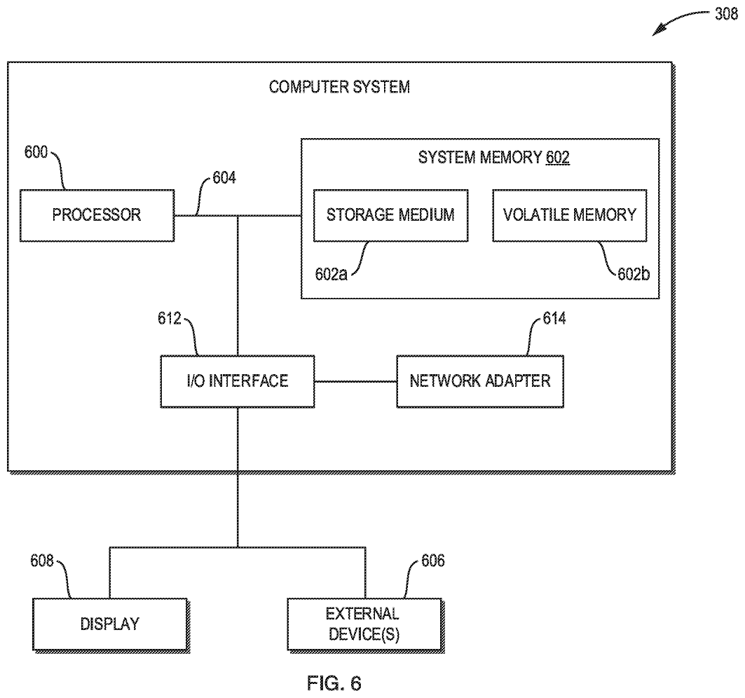

By way of example, FIG. 6 schematically depicts an example of an implementation of the controller 308 according to the present teachings that is configured for dynamically adjusting the bandpass window of the ion guide can include one or more processors or processing units 600, a system memory 602, and a bus 604 that allows communication between various components of the controller including the system memory 602 to the processor 600.

The system memory 602 includes a computer readable storage medium 602a and volatile memory 602b (e.g., Random Access Memory, cache, etc.). As used herein, a computer readable storage medium includes any media that is capable of storing computer readable program instructions and is accessible by a computer system. The computer readable storage medium 602a includes non-volatile and non-transitory storage media (e.g., flash memory, read only memory (ROM), hard disk drives, etc.). Computer readable program instructions as described herein include program modules (e.g., routines, programs, objects, components, logic, data structures, etc.) that are executable by a processor. Furthermore, computer readable program instructions, when executed by a processor, can direct a computer system (e.g., the controller 126) to function in a particular manner such that a computer readable storage medium comprises an article of manufacture. Specifically, when the computer readable program instructions stored in the computer readable storage medium 602a are executed by the processor 600, they create means for implementing the functions specified in the present teachings. For example, the instructions can include utilizing the present teachings for identifying a plurality of precursor ions expected to arrive at an ion guide positioned upstream of a mass filter during a predefined time period subsequent to MRM analysis of a current precursor ion selected by the mass filter, determining a bandpass window for application to said ion guide based on a maximum m/z difference between an m/z of the current precursor ion and m/z ratios of said plurality of precursor ions to be analyzed in said subsequent time period, and configuring the ion guide to provide said bandpass window, e.g., via adjustment of DC voltages applied to a DC voltage source supplying DC voltages to auxiliary electrodes within the ion guide.

The bus 604 may be one or more of any type of bus structure capable of transmitting data between components of the controller (e.g., a memory bus, a memory controller, a peripheral bus, an accelerated graphics port, etc.).

In some embodiments the controller 308 may include one or more external devices 606 and a display 608. As used herein, an external device includes any device that allows a user to interact with the controller (e.g., mouse, keyboard, touch screen, etc.). The external devices 606 and the display 610 are in communication with the processor 600 and the system memory 602 via an Input/Output (I/O) interface 612. In some embodiments, the controller can further include a network adapter 614 to allow establishing communication between the controller and other devices.

The foregoing description of the embodiments has been presented for purposes of illustration only. It is not exhaustive and does not limit the embodiments to the precise form disclosed. While several exemplary embodiments and features are described, modifications, adaptations, and other implementations may be possible, without departing from the spirit and scope of the embodiments. For instance, the presented data was acquired using infusion but any mode of sample introduction may be used including LC. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature may exist in one or more embodiments

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or. Moreover, if these terms are used, a subset of a set may include one or more than one, including all, members of the set.

Further, if used in this disclosure, and unless stated or deducted otherwise, a first variable is an increasing function of a second variable if the first variable does not decrease and instead generally increases when the second variable increases. On the other hand, a first variable is a decreasing function of a second variable if the first variable does not increase and instead generally decreases when the second variable increases. In some embodiment, a first variable may be an increasing or a decreasing function of a second variable if, respectively, the first variable is directly or inversely proportional to the second variable.

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise various steps may be omitted, repeated, combined, or performed in parallel, as necessary, to achieve the same or similar objectives. Similarly, the systems described need not necessarily include all parts described in the embodiments and may also include other parts not described in the embodiments. Accordingly, the embodiments are not limited to the above-described details, but instead are defined by the appended claims in light of their full scope of equivalents. Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

Those having ordinary skill in the art will appreciate that various changes can be made to the above embodiments without departing from the scope of the present teachings.

What is claimed is:

1. A method of operating a high-throughput mass analysis device, comprising:
sampling an unseparated sample from at least one sample holding element during a sampling interval for introduction of the sample into an ion source for ionizing at least one target analyte, if any, in the sample to generate a plurality of ions for delivery to an ion mobility separation device, and
activating at least one control parameter of said ion mobility separation device for detection of said ions based on timing of the sampling of the sample and at least one sample identifier associated with the sample.

2. The method of claim 1, wherein said step of activating the at least one control parameter comprises utilizing a controller to set a value of said control parameter based on reference data indicative of said value of the control parameter suitable for identification of said at least one target analyte.

3. The method of claim 1, wherein said step of activating the at least one control parameter is further based on a time delay between the sampling of the sample and the delivery of the plurality of ions to the ion mobility separation device.

4. The method of claim 1, wherein said at least one sample identifier identifies said at least one target analyte associated with the sample.

5. The method of claim 1, wherein said at least one sample identifier identifies a duration of said sampling interval.

6. The method of claim 4, wherein said at least one sample identifier identifies a start time and an end time associated with said sampling interval.

7. The method of claim 1, wherein said at least one sample identifier identifies said at least one sample holding element.

8. The method of claim 6, wherein said at least one sample identifier identifies said at least one target analyte associated with the sample contained in said at least one sample holding element.

9. The method of claim 1, further comprising retrieving reference data indicative of said at least one target analyte and a value of the at least one control parameter from a single datafile.

10. The method of claim 1, wherein said at least one target analyte comprises a plurality of analytes and the step of activating the at least one control parameter comprises activating different values of said control parameter during the sampling interval, wherein each of the different values of the control parameter is suitable for detection of one of said plurality of analytes.

11. The method of claim 1, wherein said at least one sample holding element comprises a plurality of sample holding elements.

12. The method of claim 10, wherein said at least one sample identifier identifies one of said plurality of sample holding elements and said at least one target analyte associated with the sample contained in said identified sample holding element.

13. The method of claim 1, wherein said sampling step is performed via a plurality of discrete sampling events during said sampling interval.

14. The method of claim 1, wherein said sampling step is performed continuously during said sampling interval.

15. The method of claim 1, wherein said sampling interval is equal to or less than about 10 seconds.

16. The method of claim 14, wherein said sampling interval is in a range of about 0.5 seconds to about 10 seconds.

17. The method of claim 1, wherein said sampling step comprises utilizing an energy source for removing the sample from said sample holding element.

18. The method of claim 16, wherein said energy source comprises any of a laser, ultrasound, a acoustic source and a source for generating pneumatic pressure.

19. The method of claim 1, wherein said ion mobility separation device comprises an ion mobility spectrometer.

20. A high-throughput mass analysis device, comprising:
at least one sample holding element for storing a sample,
an ion source,
an ion mobility separation device,
a sample introduction device for directing the sample from the at least one sample holding element to the ion source,
a controller in communication with the sample introduction device for controlling sampling of the sample from said at least one sample holding element for delivery to said ion source to cause ionization of at least one target analyte, if any, in the sample, thereby generating a plurality of ions associated with said at least one target analyte, said controller further being in communication with said ion mobility separation device for controlling at least one control parameter thereof,
wherein said controller is configured to activate the at least one control parameter for detecting the target analyte in the sample based on timing of the sampling of the sample from the sample holding element and an identifier associated with the sample.
